(19) United States
(12) Patent Application Publication
(10) Pub. No.: US 2014/0259838 A1
(43) Pub. Date: Sep. 18, 2014

(54) CARD WITH EDGE INDICATORS

(71) Applicant: BANK OF AMERICA CORPORATION, Charlotte, NC (US)

(72) Inventor: Kenneth G. Tattersall, Wilmington, DE (US)

(73) Assignee: BANK OF AMERICA CORPORATION, Charlotte, NC (US)

(21) Appl. No.: 13/801,647

(22) Filed: Mar. 13, 2013

(51) Int. Cl. G09F 3/02; B32B 3/02

(52) U.S. Cl. CPC G09F 3/02; B32B 3/02
USPC 40/675; 40/299.01; 428/81

(57) ABSTRACT

Embodiments of the invention are directed to cards that comprise indicators on the edge of the card stock to help identify the card. The indicators may be projections on the edge of the card stock formed by ridges, grooves, dimples, burrs, protrusions, or other like projections that provide at least a portion of the edge of the card stock with a textured surface. A user may identify the card by viewing the projections or touching the projections on the edge of the card stock, and identifying the type of projections, height of the projections, or the spacing of the projections on the edge of the card stock. The ability to identify the card stock simply through touch may be useful to visually impaired users for differentiating between types of cards that may otherwise be difficult to identify without projections.

### BACKGROUND

Cards are used for different types of financial transactions, rewards, discounts, gifts, identification, insurance, security, and other like uses. Different types of cards may include credit cards, debit cards (e.g., automated teller machine cards), rewards cards, gift cards, identification cards (e.g., licenses, student identification cards, card badges, and the like), insurance cards (e.g., health insurance, dental insurance, and the like), security cards for entry into secure locations, and other like cards.

### BRIEF SUMMARY

The embodiments provided herein are directed to cards that comprise indicators on the edge of the card to help identify the card. As such, the indicators may allow a person presenting the card or another person accepting the card (hereinafter “user(s)”) to identify the card apart from other cards, for example either by sight or by touch. The indicators may be projections extending from or into the edge of the card. The projections may be ridges, grooves, dimples, burrs, protrusions, or other like projections that provide at least a portion of the edge of card with a textured surface identifiable by touch or sight. The card also has a first face (e.g., front face or back face) and a second face (e.g., back face or front face) (hereinafter “faces”). In some embodiments of the invention the card has a first side, a second side, a third side, and a fourth side, comprising a surface of the card extending around the sides of the card that forms an edge around the card. In other embodiments of the invention the card may have more or less sides, but the sides still form an edge around the sides of the card.

A user of the card may identify the card by viewing the indicator on the edge of the card. For example, a user may view projections on at least one edge of the card when the faces of the card cannot be viewed, or otherwise identified, such as for example when the card is located within a wallet or a purse. A user may also be able to identify the card by touching the indicator when the indicator cannot be seen. For example, a user may identify a card by touching the edge of the card and identifying the type of projections (i.e., ridge, groove, dimple, or the like), height of the projections, or the spacing of the projections on the edge of the card. The ability to identify the card simply through touch may be of useful to visually impaired users for differentiating between types of cards that may otherwise be difficult to identify without the projections.

One embodiment of the invention is card stock comprising, a first face, a second face opposite the first face, an edge around the card stock between the first face and the second face, and an indicator on at least a portion of the edge.

In further accord with an embodiment of the invention the indicator may be seen or touched to provide identification of the card stock.

In another embodiment of the invention, the indicator comprises a projection.

In still another embodiment of the invention, the projection comprises a ridge, a groove, a dimple, a burr, or a protrusion on the edge.

In yet another embodiment of the invention, the indicator comprises a plurality of projections on at least the portion of the edge.

In further accord with an embodiment of the invention, a distance between a peak of a first projection and a trough of the first projection is less than or equal to 0.003 inches.

In another embodiment of the invention, the projections comprise a first projection and a second projection adjacent the first projection, and wherein a distance between a first projection peak and a second projection peak is less than or equal to 0.04 inches.

In still another embodiment of the invention, the card stock further comprises a first side, a second side, a third side, a fourth side, and wherein the first side, the second side, the third side, and the forth side form the edge around the card stock.

In yet another embodiment of the invention, the card stock is produced by procuring two or more layers of sheets, laminating the two or more layers of sheets into a sheet stock, cutting the sheet stock into the card stock using a tool with a tool edge, and wherein the tool edge forms the indicator on at least the portion of the edge of the card stock.

In further accord with an embodiment of the invention, the two or more layers of sheets comprise a core layer made from molded plastic, an outer layer representing a first face of the card stock, and an outer layer representing a second face of the card stock.

In another embodiment of the invention, laminating the two or more layers comprises bonding a layer representing a first face of the card and a layer representing a second face of the card stock through the use of two or more rollers.

In still another embodiment of the invention, laminating the two or more layers comprises layering the two or more layers and forming the sheet stock in a heated press that applies heat and pressure to the two or more layers.

In yet another embodiment of the invention the card stock, further comprises a signature panel on the second face, a hologram on the front face or the second face, customer account information, and a customer name.

In further accord with an embodiment of the invention, the indicator is a half circle projection, sawtooth projection, or rounded projection.

Another embodiment of the invention is card stock comprising a first face, a second face opposite the first face, an edge around the card stock between the first face and the second face, rounded projections on at least a portion of the edge, and wherein the rounded projections on at least a portion of the edge results in the edge comprising a shape of a sine wave over the portion of the edge.

In further accord with an embodiment of the invention, a distance between a peak of a first rounded projection and a trough of the first rounded projection is less than or equal to 0.003 inches.

In another embodiment of the invention, the rounded projections comprise a first rounded projection and a second rounded projection adjacent the first rounded projection, and wherein a distance between a first projection peak of the first rounded projection and a second projection peak of the second rounded projection is less than or equal to 0.04 inches.

In still another embodiment of the invention the card stock further comprises a first side, a second side, a third side, a fourth side, and wherein the first side, the second side, the third side, and the forth side form the edge around the card stock.

In yet another embodiment of the invention, the card stock comprises two or more layers laminated together.

Another embodiment of the invention is card stock comprising a first face, a second face opposite the first face, a first side, a second side, a third side, and a fourth side, wherein the first side, the second side, the third side, and the forth side form an edge around the card stock between the first face and the second face. The card stock further comprises rounded projections on at least a portion of the edge, wherein the rounded projections on at least a portion of the edge result in the edge comprising a shape of a sine wave over the portion of the edge. The rounded projections comprise a first projection and a second projection adjacent the first projection, wherein a height distance between a first projection peak of the first rounded projection and a first projection trough of the first rounded projection is less than or equal to 0.003 inches, and wherein a width distance between the first projection peak of the first projection and a second projection peak of the second projection is less than or equal to 0.04 inches.

To the accomplishment the foregoing and the related ends, the one or more embodiments comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a method for producing card stock with an indicator, in accordance with an embodiment of the invention;

FIG. 2A is a plan view of an edge of a tool with tool projections and an edge of card stock with card projections, in accordance with an embodiment of the invention;

FIG. 2B is a plan view of an edge of a tool with tool projections and an edge of card stock with card projections, in accordance with an embodiment of the invention;

FIG. 3 is a plan view of an edge of a tool with tool projections and an edge of card stock with card projections, in accordance with an embodiment of the invention;

FIG. 4 is a perspective view of a card with an indicator on the edge of the card, in accordance with an embodiment of the invention;

FIG. 5 is a first face view of a card with an indicator on the edge of the card, in accordance with an embodiment of the invention;

FIG. 6 is a second face view of a card with an indicator on the edge of the card, in accordance with an embodiment of the invention;

FIG. 7 is a first side view of a card with an indicator on the edge of the card, in accordance with an embodiment of the invention;

FIG. 8 is a second side view of a card with an indicator on the edge of the card, in accordance with an embodiment of the invention;

FIG. 9 is a third side view of a card with an indicator on the edge of the card, in accordance with an embodiment of the invention;

FIG. 10 is a fourth side view of a card with an indicator on the edge of the card, in accordance with an embodiment of the invention;

FIG. 11A illustrates a plan view of a card with an indicator on a portion of the edge of the card, in accordance with an embodiment of the invention;

FIG. 11B illustrates a plan view of a card with an indicator on a portion of the edge of the card, in accordance with an embodiment of the invention;

FIG. 11C illustrates a plan view of a card with an indicator on a portion of the edge of the card, in accordance with an embodiment of the invention;

FIG. 12 illustrates a plan view and a magnified view of a card illustrating the spacing of an indicator, in accordance with an embodiment of the invention;

FIG. 13 illustrates a plan view and a magnified view of a card illustrating the spacing of an indicator, in accordance with an embodiment of the invention;

FIG. 14 illustrates a view of a portion of a card with an indicator, in accordance with an embodiment of the invention;

FIG. 15 illustrates a view of a portion of a card with an indicator, in accordance with an embodiment of the invention;

FIG. 16 illustrates a view of a portion of a card with an indicator, in accordance with an embodiment of the invention;

FIG. 17 illustrates a plan view of a card with an indicator on a portion of the edge of the card, in accordance with an embodiment of the invention;

FIG. 18 is a perspective view of a card with an indicator on the edge of the card, in accordance with an embodiment of the invention;

FIG. 19 is a first face view of a card with an indicator on the edge of the card, in accordance with an embodiment of the invention;

FIG. 20 is a second face view of a card with an indicator on the edge of the card, in accordance with an embodiment of the invention;

FIG. 21 is a first side view of a card with an indicator on the edge of the card, in accordance with an embodiment of the invention;

FIG. 22 is a second side view of a card with an indicator on the edge of the card, in accordance with an embodiment of the invention;

FIG. 23 is a third side view of a card with an indicator on the edge of the card, in accordance with an embodiment of the invention; and

FIG. 24 is a fourth side view of a card with an indicator on the edge of the card, in accordance with an embodiment of the invention.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

FIG. 1 illustrates a flowchart for manufacturing a card with an indicator, in accordance with one embodiment of the invention. As illustrated by block 10 in FIG. 1, a core layer for the card is procured by purchasing or creating the core layer. In one embodiment of the invention, melted plastic is molded into a thin plastic sheet. For example, the core layer may be formed through an extrusion molding process. In other embodiments the core layer may be molded using other molding processes. Instead of molding the core layer from plastic, in some embodiments, the core layer may be formed from another material using another process. The core layer may be formed from a particular color, or otherwise, painted, printed on, or the like, to display a color or design (e.g., logo, word, or the like) that a customer desires on the card. In some embodiments of the invention there may be one or more core layers.

As illustrated by block 20, one or more outer layers are procured by purchasing or creating the one or more outer layers. In one embodiment the outer layers are also created from plastic, for example also through an extrusion process. In other embodiments, the outer layers may be created through other processes. The outer layers may be painted or printed (e.g., ink printed, laser printed, screen printed, or the like) with the color scheme and wording desired by the customer. In some embodiments, at least a portion of an outer layer is clear, and the color scheme of the card is created on the core layer, as previously described. In some embodiments, the core layer does not exist and only the outer layers are used to create the card (e.g., a front layer and back layer). In still other embodiments of the invention, there may be multiple outer layers on either side of the faces of the core layer.

In some embodiments, as illustrated by block 30 in FIG. 1, an information storage feature may be associated with the core layer or the one or more outer layers. The information storage feature may be a magnetic strip, barcode, radio frequency identifier (RFID) tag, optical storage device, smart card chip, or other like information storage feature. For example, one of the outer layers may be overlaid with a magnetic strip when the card is a financial institution card (e.g., credit card, debit card, gift card, or the like), an identification card, or a security card. In other examples, a bar code may be printed on the core layer or the outer layer. In still other examples, the RFID tag, optical storage device, or smart card chip may be affixed to the core layer or the outer layer. The process of associating the information storage feature to the card may be done before or after the core layer and/or the one or more outer layers are secured together.

As illustrated by block 40 in FIG. 1, the layers are secured together to form a sheet stock (e.g., sheet blank). In one embodiment of the invention, the layers may be laid on top of one another and placed into a press that may heat and apply pressure to the layers to form the sheet stock. In other embodiments of the invention, a roller system may be used to form the layers together. For example, outer layers on rolls may be laminated to a core layer using heat and pressure as the outer layers are applied to the core layer. In some embodiments the layers may include a core layer, a front outer layer, and a back outer layer. In other embodiments of the invention the layers may only include a front layer and a back layer (or core layer). In still other embodiments, there may be multiple front layers and back layers. The present invention covers any number of different layers that are formed together to create the sheet stock.

Block 50 of FIG. 1 illustrates that the sheet stock is cut into card stock (e.g., one or more card blanks), with the indicator on the edge of the card stock. In some embodiments of the invention the sheet stock is cut or stamped using one or more tools, such as dies, that form the card stock with the indicators on at least a portion of the edge of the card stock. The dies used to form the card stock may be plates or other like tools that have an outer die edge with the same projections and dimensions as described below with respect to the card stock. In this way a die may be a mirror image of the card stock and be used to punch or cut out card stock with the same type of projections and projection dimensions as described herein with respect to the card stock. In other embodiments of the invention, the dies used to form the card stock may have a cavity (e.g., die cavity) with an inner die edge having the opposite projections and dimensions as described herein with respect to the card stock. In this way a die may have the opposing image of the card stock and be used to punch or cut out the card stock with the desired type of projections and projection dimensions as described herein with respect to the card stock (e.g., see FIGS. 2A, 2B, and 3). In still other embodiments the dies may be one or more blades (e.g., die blades) that punch or cut one or more of the edges of the card stock as described herein. In still other embodiments of the invention the dies may be cooperating dies that work together to form the card stock with the desired edge indicators. For example, in one embodiment a die punch with die punch projections having the mirror image of the desired card stock may work in connection with a die cavity with die cavity projections that are opposite the die punch projections and desired card projections, such that the die punch and die cavity stamp out the card stock with the desired card projections. Regardless of the type of dies used to form the card stock, the dies used in the present invention are configured to punch or stamp the card stock with edge indicators, as described herein. In other embodiments of the invention the sheet stock may be cut using other types of cutting devices.

As illustrated in block 60 of FIG. 1, at least one security feature may be attached to the card stock, if necessary. The security features may include a signature strip, hologram, photo, security tape, or other like security feature. In some embodiments one or more of these security features may be incorporated into the core layer or one or more outer layers of the card before or after various steps within the card manufacturing process described herein.

The manufacturer may store the card stock until the card stock is ready for personalization, the card stock may be shipped to the institution that ultimately provides the card to the customer, or the card stock may be sent to another party for additional manufacturing. In some embodiments, the card stock is ready for use by an institution after the card stock is cut from the sheet stock. For example, in the case of reward cards or gift cards, the card stock may be shipped to a store, at which the store may ultimately associate the card with a customer or dollar amount. In an example where the card is an identification card, the card stock may be sent to a secure agency that associates the card with a person, for example prints or affixes a photo on the card stock, and/or stores data on the information storage feature (e.g., magnetic strip or RFID tag). In other embodiments of the invention, for example, in the case of financial institution cards, the card stock is sent to a secure location for additional processing of the card with personalized financial information.

As illustrated by block 70 in FIG. 1, personalized information may be associated with the card stock. As previously discussed this may include printing photo identification onto the card, with respect to an identification card or security card. In other embodiments of the invention, the personalized information may be an account number or customer name that is printed, stamped, embossed, or otherwise attached to or formed into the card. For example, with respect to financial institution cards (e.g., credit card, debit card, and the like) a customer name, account number, and expiration date may be embossed into the card stock to form the card.

Block 80 of FIG. 1 illustrates that information may also be stored on or associated with the information storage feature of the card stock. For example, with respect to financial institution cards, account information, customer information, financial institution communication information (e.g., where to route requests for purchases), or other like information may be stored on a magnetic strip of the card. In other embodiments, for example with respect to gift cards, prepaid cards, or the like, the dollar amount of the card may be stored on the magnetic strip of the card. In still other embodiments of the invention, for example with respect to security cards or identification cards, the magnetic strip may hold information about security clearance, personal identification information about the card holder, communication information to allow access to a database that contains information, access information to allow access to a secure location, or other like information. In other embodiments, the information stored may be stored on information storage features other than a magnetic strip, as previously discussed. With respect to reward cards, the information storage feature may be a bar code that is associated with a particular customer in a database in order to provide rewards to the customer based on the customer's purchases or the customer's profile. Embodiments of the present invention may create cards with indicators, on which various types of information may be stored or associated with the information storage feature of the card.

FIG. 2A illustrates one embodiment of a plan view of the edge of a tool (e.g., die) used to create a card indicator 400 (e.g., projections 402) on an edge of a card, in accordance with an embodiment of the invention. As illustrated in FIG. 2A, the tool 200 (e.g., die) has a tool edge 202 (e.g., die edge) with tool projections 204, such as a plurality of inverted half circles 210 with tool peaks 212 and tool troughs 214 that are used to form the card indicator 400 on the card edge 302 of the card stock 300. The tool edge 202 is similar to a sawtooth, serrated knife, triangular point, or other like edge that forms the half circle projections 410 on the card edge 302. In some embodiments of the invention, the half circle projections 410 have projection peaks 412 and projection troughs 414. The projection peaks 412 may have rounded ends in some embodiments (as illustrated in FIG. 2A). The projection troughs 414 may have pointed troughs in some embodiments (as illustrated in FIG. 2A).

In some embodiments of the invention the tool edge 202 and card edge 302 described with respect to FIG. 2A are reversed, as illustrated in FIG. 2B. As such, the tool 200 (e.g., die) has a tool edge 202 with tool projections 204, such as a plurality of half circles 220 projecting from the tool 200 with tool peaks 222 and tool troughs 224 that are used to form the card indicator 400 (e.g., projections 402) on the card edge 302 of the card 300. The tool edge 202 is used to form the sawtooth projections 420 on the card edge 302. The tool edge 202 in FIG. 2B is similar to a half-circle edge, or other like edge that forms the sawtooth projections 420 on the card edge 302. In this embodiment the sawtooth projections 420 have projection peaks 422 and projection troughs 424. The projection peaks 422 of the card edge 302 are illustrated as having a point, while the projection troughs 424 are substantially half circles.

In some embodiment of the invention, as illustrated in FIG. 3, the tool 200 (e.g., die) has a tool edge 202 with tool projections 204, such as rounded features 230 projecting from the tool 200, with rounded tool peaks 232 and rounded tool troughs 234 that are used to form the card indicator 400 on the card edge 302 of the card 300. The tool edge 202 is used to form the rounded projections 430 on the card edge 302. In this embodiment the rounded projections 430 have projection peaks 432 and projection troughs 434 that are both rounded for forming a card edge 302 that is in the shape of a sine wave, such that the projection peaks 432 and projection troughs 434 have the same or similar dimensions.

In other embodiments of the invention, the tool peaks and tool troughs may have other shapes not explicitly described herein that produce projection peaks and projection troughs in the card edge 302 that are not explicitly described herein.

Regardless of the various configurations of the tool edge 202, the tool 200 is configured cut sheet stock into card stock 300. The tool 200 cuts sheet stock such that the card edge 302 of the card stock 300 has a projection 402 over at least a portion of the card edge 302.

FIG. 4 illustrates a perspective view of a financial card 500, such as a debit card or credit card, made from card stock 300. In the illustrated embodiment the financial card 500 has a first side 502, a second side 504, a third side 506, and a fourth side 508, comprising a surface of the card extending around the outside of the card forming the edge 510 of the card. As previously discussed the edge 510 of the financial card 500 has a card indicator 400 that is formed on the card stock. As illustrated in FIG. 4, the card indicator 400 may be located around the entire edge 510 of the card. In the illustrated embodiment, the card indicator 400 comprises projections 410 that are semi-circular (e.g., half-circle) projections 410. However, as previously discussed and outlined in further detail later the projections 402 may be simi-circular, pointed, rounded, or have another type of shape.

FIG. 5 illustrates one embodiment of the first face 512 of the financial card 500. In the illustrated embodiment, the first face 512 of the financial card 500 is the front face. The front face has an institution name and/or logo, an embossing of the card owner's account number and name, as well as the card's expiration date. In other embodiments of the invention the first face 512 may be the back face of the card. The first face 512 of the card may have different types of writing, logos, pictures, or the like depending on the intended use of the card.

FIG. 6 illustrates one embodiment of the second face 514 of the financial card 500. In the illustrated embodiment, the second face 514 of the financial card 500 is the back face. The back face has a magnetic strip, a signature block, a security code, and other potential features. In other embodiments of the invention the second face 514 may be the front face of the card. The second face 512 of the card may have different types of writing, logos, pictures, or the like depending on the intended use of the card.

FIG. 7 illustrates one embodiment of the first side 502 of the financial card 500 with the semi-circular projections 410. In the illustrated embodiment the first side 502 is the top edge of the financial card 500, however, in other embodiments of the invention the first side 502 may be another side of the financial card 500.

FIG. 8 illustrates one embodiment of the second side 504 of the financial card 500 with the semi-circular projections 410. In the illustrated embodiment the second side 504 is the right edge of the financial card 500, however, in other embodiments of the invention the second side 504 may be another side of the financial card 500.

FIG. 9 embodiment of the third side 504 of the financial card 500 with the semi-circular projections 410. In the illustrated embodiment the third side 506 is the bottom edge of the financial card 500, however, in other embodiments of the invention the third side 506 may be another side of the financial card 500.

FIG. 10 illustrates one embodiment of the fourth side 508 of the financial card 500 with the semi-circular projections 410. In the illustrated embodiment the fourth side 508 is the left edge of the financial card 500, however, in other embodiments of the invention the fourth side 508 may be another side of the financial card 500.

In other embodiments of the invention, instead of the semi-circular projections 410 illustrated with respect to FIGS. 4-10, the financial card 500 (or other type of card) may have projections 402 of different shapes, such as the rounded projections 430 illustrated in FIGS. 18-24. As illustrated in FIGS. 18-24, and as previously described with respect to FIG. 3 the edges on the sides 502, 504, 506, 508 of the card 500 may have rounded projections 430 that create a card edge 302 that has the shape of a sine wave.

In the present invention, the card indicator 400, for example the projections 402 on the card edge 302 of the card stock 300, may be located over the entire card edge 302 of the card stock 300 or along only a portion of the card edge 302 of the card stock 300. Along with the different types of projections 402, the location of the projections 402 on the card edge 302 may allow a user to differentiate one type of card from another type of card. In order to create the different types of projections 402 along different portions of the card edge 302 of the card stock 300, the tool edge 202 of the tool 200 is configured with tool projections 204 (e.g., projections on the cutting or punching edge of the tool) that are used to create the desired type of card edge 302 on the card stock 300. Therefore, in some embodiments of the invention the tool projections 204 are formed around substantially the entire tool edge 202 of the tool 200, such that the card stock 300 ultimately formed from the sheet stock comprises a card indicator 400 around the entire card edge 302, as is illustrated in FIGS. 5-10 and 18-24. In other embodiments of the invention, the tool projection 204 is formed on only one or more sides or corners of the tool 200, such that the card stock 300 ultimately formed from the sheet stock comprises a card indicator 400 on one or more of the sides or corners of the card stock 300, as illustrated in FIG. 11A (e.g., projections 402 on the first side 502 and third side 506), 11B (e.g., projections 402 on the second side 504 and fourth side 408), and 11C (e.g., projections 402 on the corners 516). In some embodiments the tool projection may be located along the entire length, or along only a portion of the length, of the one or more sides or corners of the tool 200, such that the card stock 300 ultimately formed from the sheet stock comprises a card indicator 400 on a portion, or the entire length, of the sides or corners of the card stock 300.

FIGS. 12 and 13 illustrate two embodiments of the card, wherein the projections 402 are spaced apart at different intervals along at least a portion of the card edge 302. The reference letter H illustrates the height of the projections 402 from the peak of the projections 402 to the trough of the projections 402. The reference letter W illustrates the width of the projections 402 from a first peak of a projection 402, to a second peak of a projection 402 adjacent the first peak. In some embodiments of the invention the peak of the projections 402 will not extend greater than 0.003″ H above the trough of the projections 402. However, in some embodiments of the invention the difference may be less than or equal to 0.005″, less than or equal to 0.010″, less than or equal to 0.020″, less than or equal to 0.03″, less than or equal to 0.04″, less than or equal to 0.05″, less than or equal to 0.1″ or the like, or otherwise, be between two or more of these distances, or outside of these distances.

The projections 402 may also be spaced apart a number of different distances. In one embodiment of the invention, a first projection peak 522 may be located adjacent a second projection peak 524 located at a distance W of approximately 0.003″. The distance W between a first peak 522 and a second peak 524, in other embodiments may be approximately 0.037″, as illustrated in FIG. 12. The distance W between a first peak 522 and a second peak 524, in other embodiments may be approximately 0.16″, as illustrated in FIG. 13. In still other embodiments of the invention, the distance W between a first peak 522 and a second peak 524 may be between 0.003″ to 0.037″, less than or equal to 0.005″, less than or equal to 0.010″, less than or equal to 0.020″, less than or equal to 0.030″, less than or equal to 0.040″, less than or equal to 0.050″, less than or equal to 0.1″, less than or equal to 0.2″, or the like, or otherwise, be between two or more of these distances, or outside of these distances. The differences in the distances H and W described with respect to FIGS. 12 and 13, apply equally to the projections 402 that are illustrated in the other figures herein. Therefore, in some embodiments of the invention the distances described with respect to the projections 402 above may apply to the projections 402 illustrated in FIGS. 2-11C, and 14-24, as well as other types of projections 402 not specifically described herein.

Furthermore, the dimensions described above with respect to the card projections 402 on the card stock 300, may apply to the tool projections 204 on the tool 200 that are used to create the card projections 402 on the card stock 300.

FIG. 14 illustrates another embodiment of the invention, wherein the projections 402 are v-shaped projections 470 on at least a portion of the edge 302 of card stock 300. In the embodiment illustrated in FIG. 14 the v-shaped projections 470 are located on the corner 516 of the card stock 300, and/or along two perpendicular sides of the card stock 300. In other embodiments of the invention, the v-shaped projections 470 may be located along a portion of one or more sides of the cards (e.g., a first side 502, a second side 504, a third side 506, or a fourth side 508).

FIG. 15 illustrates another embodiment of the invention, wherein the projections 402 are trapezoidal projections 480 on at least a portion of the edge 302 of card stock 300. In the embodiment illustrated in FIG. 15 the trapezoidal projections 480 are located on the corner 516 of the card stock 300, and/or along the perpendicular sides of the card stock 300. In other embodiments of the invention, the trapezoidal projections 480 may be located along a portion of one or more sides of the cards (e.g., a first side 502, a second side 504, a third side 506, or a fourth side 508).

FIG. 16 illustrates another embodiment of the invention, wherein the projections 402 are sine wave projections 490 in the shape of a sine curve. In the embodiment illustrated in FIG. 16 the sine wave projections 490 are located on the corner 516 of the card stock 300, and/or along two perpendicular sides of the card stock 300. In other embodiments of the invention, the sine wave projections 490 may be located along a portion of one or more sides of the cards (e.g., a first side 502, a second side 504, a third side 506, or a fourth side 508). The sine wave projections 490 are further illustrated in FIGS. 18-24.

In still other embodiments of the invention the projections 402 may be of any type of shape and size. Furthermore, the projections 402 may either project from a surface of the edge 302 of the card stock 300, or project into the edge 302 of the surface of the card stock 300. The projections 402 (or the reverse image of the projections 402) illustrated and described with respect to FIGS. 14-16, may also illustrate and describe the tool projections 204 (or the reverse image of the tool projections 204) that are used to create the card edges 302 of the card stock 300.

FIG. 17 illustrates another embodiment of the invention wherein the card is a mini-card 600, which is configured with an aperture 620 therethrough in order to allow for attachment to a key-ring. In some embodiments of the invention, the mini-card 600 is configured with projections 402 around at least a portion of the mini-card 600 in the card stock 300. In some embodiments of the invention the mini-card 600 has a first side 602, a second side 604, a third side 606, a fourth side 608, and corners 616, comprising a mini-card edge 610, a first face 612, and a second face (not illustrated). In some embodiments the mini-card 600 is configured to snap out of shell 630 such that one or more sides of the mini-card 600 may be attached to the shell 630 along a perforated edge 640. The mini-card 600 may be popped out of the shell 630 by breaking the perforated edge 640.

In some embodiments of the invention the mini-card may have projections 402 along portions of one or more of the first side 602, second side 604, third side 606, or fourth side 608. As illustrated in FIG. 17 the first side 602 is the top side, the second side 604 is the right side, the third side 606 is the bottom side, and the fourth side 608 is the left side of the mini-card 600. One or more of the corners 616 may or may not have the projections 402. In some embodiments, the projections 402 may be on the second side 604 and third side 606, and may be secured to the perforated edge 640 of the shell 630. The mini-card 600 may be separated from the shell 630 for use. In other embodiments, the projections 402 may not be located on the perforated edge 640 between the shell 630 and one or more of the second side 604 and third side 606. The shell 630 may have an outer edge 632 that may or may not have projections 402, while the inner edge 634 of the shell 630 also may or may not have projections 402 based on whether or not the side of the mini-card 600 to which the shell 630 is connected has projections 402. The tool 200 used to create the mini-card 600 would have the tool projections 204 that form the card projections 402 on the one or more surfaces of the mini-card 600.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A card stock comprising:
a first face;
a second face opposite the first face;
an edge around the card stock between the first face and the second face; and
an indicator on at least a portion of the edge.

2. The card stock of claim 1, wherein the indicator may be seen or touched to provide identification of the card stock.

3. The card stock of claim 1, wherein the indicator comprises a projection.

4. The card stock of claim 3, wherein the projection comprises a ridge, a groove, a dimple, a burr, or a protrusion on the edge.

5. The card stock of claim 1, wherein the indicator comprises a plurality of projections on at least the portion of the edge.

6. The card stock of claim 5, wherein a distance between a peak of a first projection and a trough of the first projection is less than or equal to 0.003 inches.

7. The card stock of claim 5, wherein the projections comprise a first projection and a second projection adjacent the first projection, and wherein a distance between a first projection peak and a second projection peak is less than or equal to 0.04 inches.

8. The card stock of claim 1, further comprising:
a first side;
a second side;
a third side;
a fourth side; and
wherein the first side, the second side, the third side, and the forth side form the edge around the card stock.

9. The card stock of claim 1, wherein the card stock is produced by procuring two or more layers of sheets;
laminating the two or more layers of sheets into a sheet stock;
cutting the sheet stock into the card stock using a tool with a tool edge; and
wherein the tool edge forms the indicator on at least the portion of the edge of the card stock.

10. The card stock of claim 9, wherein the two or more layers of sheets comprise:
a core layer made from molded plastic;
an outer layer representing a first face of the card stock; and
an outer layer representing a second face of the card stock.

11. The card stock of claim 9, wherein laminating the two or more layers comprises bonding a layer representing a first face of the card and a layer representing a second face of the card stock through the use of two or more rollers.

12. The card stock of claim 9, wherein laminating the two or more layers comprises layering the two or more layers and forming the sheet stock in a heated press that applies heat and pressure to the two or more layers.

13. The card stock of claim 1, further comprising:
a signature panel on the second face;
a hologram on the front face or the second face;
customer account information; and
a customer name.

14. The card stock of claim 1, wherein the indicator is a half circle projection, sawtooth projection, or rounded projection.

15. A card stock comprising:
a first face;
a second face opposite the first face;
an edge around the card stock between the first face and the second face;
rounded projections on at least a portion of the edge; and
wherein the rounded projections on at least a portion of the edge results in the edge comprising a shape of a sine wave over the portion of the edge.

16. The card stock of claim 15, wherein a distance between a peak of a first rounded projection and a trough of the first rounded projection is less than or equal to 0.003 inches.

17. The card stock of claim 15, wherein the rounded projections comprise a first rounded projection and a second rounded projection adjacent the first rounded projection, and wherein a distance between a first projection peak of the first rounded projection and a second projection peak of the second rounded projection is less than or equal to 0.04 inches.

18. The card stock of claim 15, further comprising:
a first side;
a second side;
a third side;
a fourth side; and
wherein the first side, the second side, the third side, and the forth side form the edge around the card stock.

19. The card stock of claim 1, wherein the card stock comprises two or more layers laminated together.

20. A card stock comprising:
a first face;
a second face opposite the first face;
a first side;
a second side;
a third side;
a fourth side;
wherein the first side, the second side, the third side, and the forth side form an edge around the card stock between the first face and the second face;
rounded projections on at least a portion of the edge, wherein the rounded projections on at least a portion of the edge result in the edge comprising a shape of a sine wave over the portion of the edge;
wherein the rounded projections comprise a first projection and a second projection adjacent the first projection,
wherein a height distance between a first projection peak of the first rounded projection and a first projection trough of the first rounded projection is less than or equal to 0.003 inches; and
wherein a width distance between the first projection peak of the first projection and a second projection peak of the second projection is less than or equal to 0.04 inches.
